(19) United States
(12) Patent Application Publication
(10) Pub. No.: US 2022/0284297 A1
(43) Pub. Date: Sep. 8, 2022

(54) COMPILER-BASED NEURON-AWARE DEEP NEURAL NETWORK ENSEMBLE TRAINING

(71) Applicant: Northwestern University, Evanston, IL (US)

(72) Inventors: Ettore Maria Giuseppe Trainiti, Evanston, IL (US); Simone Campanoni, Evanston, IL (US); Douglas C. Downey, Evanston, IL (US)

(21) Appl. No.: 17/688,654

(22) Filed: Mar. 7, 2022

Related U.S. Application Data
(60) Provisional application No. 63/158,211, filed on Mar. 8, 2021.

(51) Int. Cl. G06N 3/08; G06N 3/04

(52) U.S. Cl. CPC G06N 3/082; G06N 3/0454

(57) ABSTRACT

Extensive training of DNNs may take a significant amount of time due to redundancy in data processing within network nodes. Improvement may be made by a method for training a Deep Neural Network (DNN) ensemble, include the steps of: executing by at least a processor in a computer, program code of a compiler which is stored in a non-transitory computer-readable medium, wherein the compiler configures a Deep Neural Network (DNN) into N networks to perform training steps: (a) receiving, a plurality of inputs i . . . I, by a plurality of neurons ni . . . nx, wherein each neuron ni being a computation node comprised in the N networks of the DNN; (b) utilizing by the compiler, the plurality of inputs i . . . I to train to the N networks to ensemble the DNN through analyzing, identifying and removing inter-network neuron redundancy to obtain savings in training time constraints and a reduction in original memory footprint.

### CROSS-REFERENCE TO RELATED APPLICATIONS

This disclosure claims priority to and the benefit of United States Provisional Patent Application Serial No. 63/158,211 titled “Compiler-Based Neuron-Aware Deep Neural Network Ensemble Training,” filed on Mar. 8, 2021, which is incorporated by reference in its entirety.

### TECHNICAL FIELD

The present disclosure generally relates to Deep Neural Networks, and more specifically to compiler-based neuron-aware Deep Neural Network ensemble training.

### BACKGROUND

Deep Neural Networks (DNNs) are redefining the state-of-the-art performance on a growing number of tasks in many different domains like speech recognition and image classification. These impressive results are enabled by ensembling many DNNs together. Ensembling is often done by training several DNN instances from scratch and combining them also known as aggregation. Such applications may be found in consumer products. Although DNNs achieve high-quality results after extensive training, nevertheless, the training of DNN and the ensembling of the DNN take a significant amount of time.

### SUMMARY

To facilitate understanding of the disclosure, certain description of the drawings may be out-of-sequence or referenced to multiple drawings to describe similar embodiments and their variations.

In an example, a method for training a Deep Neural Network (DNN) ensemble is disclosed. The method may include the steps of: executing by at least a processor in a computer, program code of a compiler which is stored in a non-transitory computer-readable medium, wherein the compiler configures a Deep Neural Network (DNN) into N networks to perform training steps of: (a) receiving, a plurality of inputs i . . . I, by a plurality of neurons ni . . . nx, wherein each neuron ni being a computation node comprised in the N networks of the DNN; (b) utilizing by the compiler, the plurality of inputs i . . . I to train the N networks to ensemble the DNN through analyzing, identifying and removing inter-network neuron redundancy in the N networks to obtain both savings in training time constraints and a reduction in original memory footprint.

In another example, a system for training a Deep Neural Network (DNN) ensemble is disclosed. The system may include: a plurality of neurons ni . . . nx, wherein each neuron ni being a computation node in the DNN; at least a processor in a computer that executes program code of a compiler which is stored in a non-transitory computer-readable medium, wherein the compiler is enabled to configure a Deep Neural Network (DNN) into N networks to perform training steps, including: (a) receive a plurality of inputs i . . . I by a plurality of neurons ni . . . nx, wherein each neuron ni being a computation node comprised in the N networks of the DNN; and (b) utilize the plurality of inputs i . . . I to train the N networks to ensemble the DNN through analyzing, identifying and removing inter-network neuron redundancy in the N networks to obtain both savings in training time constraints and a reduction in original memory footprint.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1 illustrates an ensemble effect plot of different Deep Neural Networks (DNNs).

FIG. 2 illustrates redundancy contribution plot caused by same outcomes generated in the ensemble composed in the DNNs.

FIG. 3 illustrates a Compiler-based Neuron-aware Ensemble Training system.

FIG. 4 illustrates a method of redundancy elimination in the Compiler-based Neuron-aware Ensemble Training system.

FIG. 5A illustrates an example of DNNs ensemble composed of independently trained networks.

FIG. 5B illustrates an example of DNNs ensemble generated by Compiler of Deep Ensembles (CODE).

FIG. 5C illustrates a structure of a single CODE DNN instance.

FIG. 6 illustrates training time needed by CODE to achieve the same output quality of the baseline of Table 1.

FIG. 7 illustrates a CODE Ensembles memory footprint with respect to base line for the entries of Table 1.

FIG. 8 illustrates a Table 1 showing an output quality of the benchmarks of DNNs in FIG. 1.

FIGS. 9A and 9B illustrate a Table 2 displaying a comparison of the ensemble quality is given to baseline and CODE when the same training time budget and when no training time budget constraint is given.

FIG. 10 is a flow chart illustrating a method of the Compiler-based Neuron-aware Ensemble training as depicted in FIGS. 3 and 4.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Reference designations may be mentioned out of order to illustrate their locations in the referenced figures. In addition, the term “CODE” and “CODE tool” may be used interchangeably throughout the description.

It is known that DNNs may achieve high-quality results after extensive training, which may take a significant amount of time. There are two main factors contributing to why Deep Neural Networks (DNNs) training may take so long. First, training a single DNN may require tuning a massive number of parameters which define an enormous solution space that must be searched in order to find a setting that results in strong DNN output quality. Although optimization techniques that are variants of stochastic gradient descent may be effective at finding high quality DNNs, such techniques may still require many iterations over large datasets. A second reason, that results in increased DNN training time, is an aggregation technique known as ensembling. Often, the best output-quality may be achieved by training multiple independent DNN instances and combining them. An output of the DNNs ensemble is a result of this aggregation.

The disclosure to follow illustrates that using a compiler-based approach to train ensembles of DNNs may achieve the same output quality obtained by homogeneous ensembles of independently trained networks with only a fraction of their training time and memory footprints.

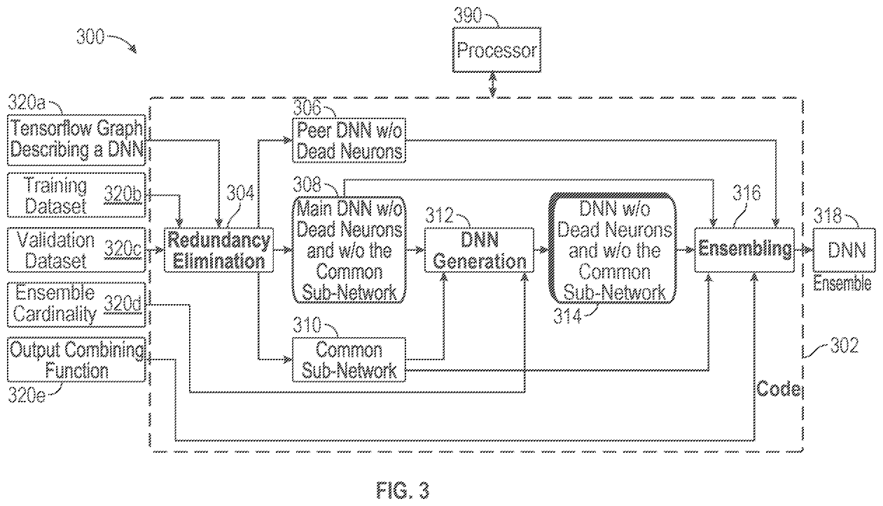

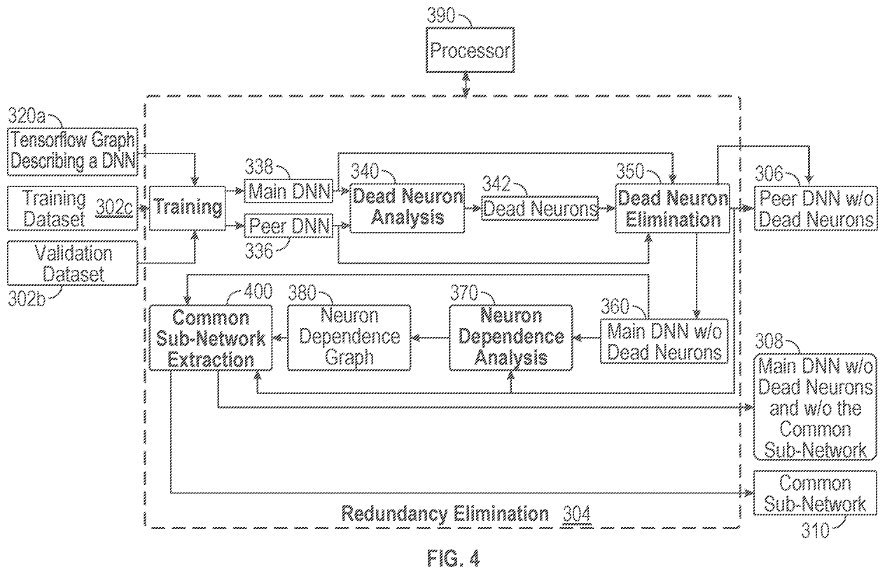

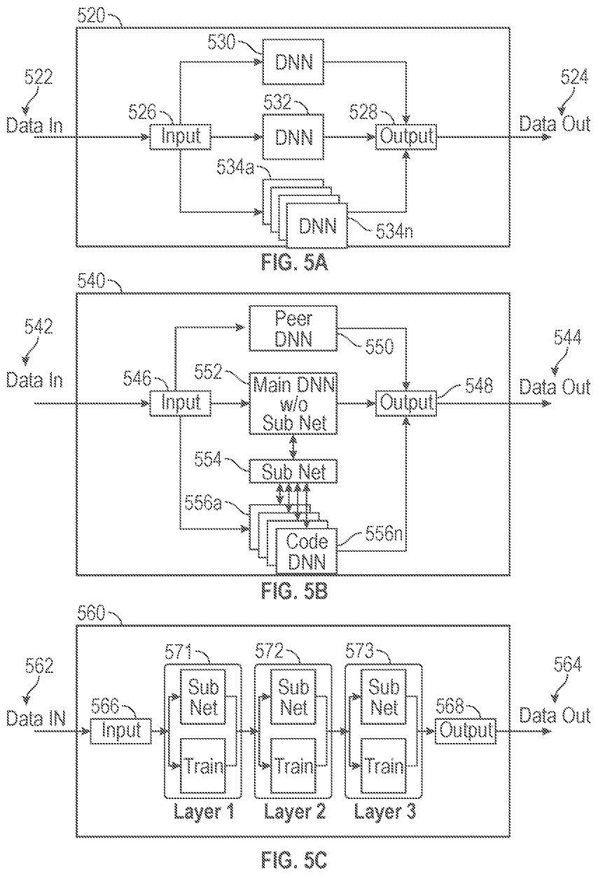

Training a single DNN may require tuning a massive number of parameters. These parameters that define the enormous solution space must be searched in order to find a setting that results in strong DNN output quality. Optimization techniques that are variants of stochastic gradient descent may be effective at finding high quality DNNs, but may still require many iterations over large datasets. For example, powerful hardware accelerators like graphical processing units (GPUs) or tensor processing units (TPUs) (e.g., processor 390 in FIGS. 3 and 4) may be necessary to explore this space fast enough to keep the training time down to acceptable levels. In addition, the ensembling technique in the DNN training in the machine learning domain to obtain the best output-quality may require training multiple independent DNN instances 530, 532, 534a-534n (e.g., see FIG. 5A) and combining them. Therefore, this disclosure provides techniques to reduce training time resulting from homogeneous DNN ensembling.

For better understanding, ensembling may be leveraged in a variety of domains (e.g., image classification, language modeling) in which the DNNs are employed. In all of these domains the approach used to ensemble N networks of the DNNs may explore after randomly setting the parameters of all DNN instances, each DNN instance 530, 532, 534a-534n (e.g., see FIG. 5A) may have its parameters tuned independently from any other instance.

Once training is completed, a DNN designer may manually ensemble all these trained DNNs (see FIG. 5A). To do so, the designer may introduce a dispatching layer 526 as input and a collecting layer 528 as output. The dispatching layer may dispatch a given input to every DNN that is participating in the ensemble, and the collecting layer may collect the outputs of these DNNs and aggregate them using a criterion chosen by the designer. An output of the DNNs ensemble is a result of this aggregation.

In an example, the ensembling of the DNNs may be improved through a redundancy reduction 304 (see FIG. 4) in the training of the networks that together compose the ensemble. Network redundancy exists because there is a common subnetwork 310 (see FIGS. 3 and 4), between these DNN instances that compose the ensemble, which may be unnecessary. A common sub-network 310 may span across layers 571-573 of the neural network (see FIG. 5C); hence, its detection may require analyses that reach a fine granularity of a neuron which being a computational node in the N networks of the DNN.

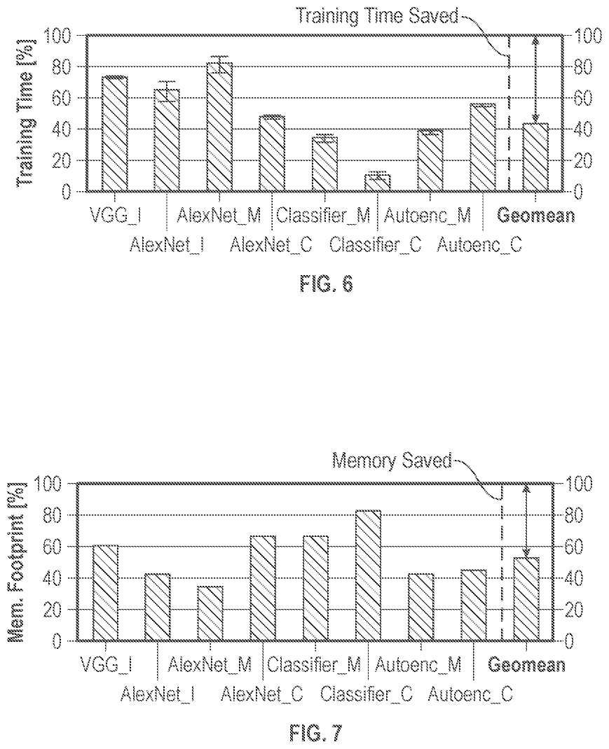

In implementation, an automatic compiler tool named “Compiler Of Deep Ensembles” (see CODE 302 in FIG. 3) may be introduced to automatically train and ensemble DNNs while significantly reducing the ensemble's training time (see FIG. 6) by avoiding retraining the common sub-network 310. Example compilers may involve Code Analysis and Transformation (CAT) to recognize and remove redundant computation performed by the instructions of program code in CODE, which introduces Neuron Analysis and Transformation (NAT) to recognize and remove redundant computation performed by the trained neurons of a DNN. The neuron-level redundancy elimination performed by the NATs may allow CODE to train an ensemble of DNNs much faster.

The CODE automatic tool 302 was tested on 8 benchmarks (see FIG. 1): it was shown that CODE 302 significantly reduces the ensemble training time (see FIG. 6) of all of the benchmarks considered. In more detail, it was determined that CODE 302 trained homogenous ensembles of DNNs that reached the same output quality of today's ensembles by using on average only 43.51% of the original training time. Exploiting the training time savings achieved by CODE 302 could result in up to 8.3% additional output quality while not exceeding the original training time. Furthermore, CODE generated ensembles having on average only 52.38% of the original memory footprint (see FIG. 7). When free from training time constraints, CODE had reached higher output quality than current ensembling approaches.

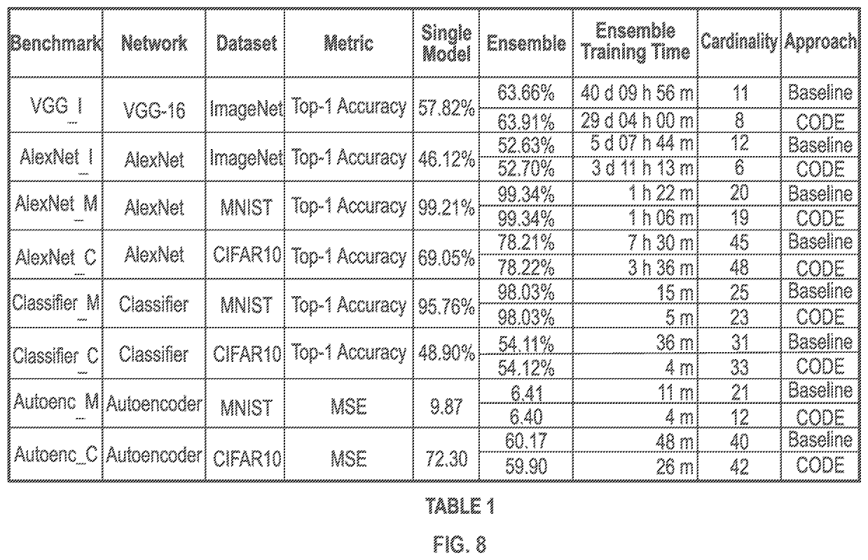

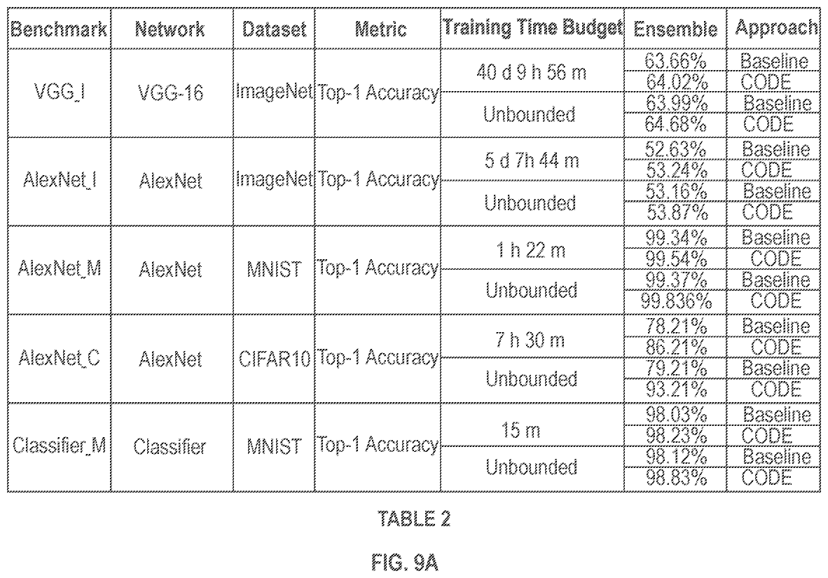

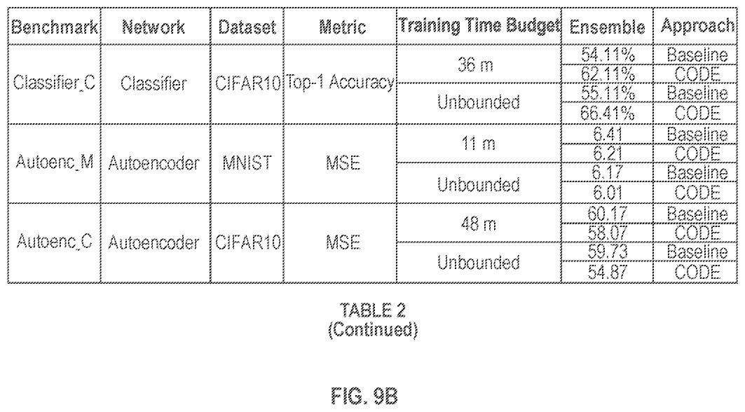

In an example, it was demonstrated that: (i) redundancy exists in today's approaches to train homogeneous ensembles of DNNs; (ii) Neuron Analyses and Transformations was introduced to automatically detect and remove redundant training; (iii) the first neuron-aware compiler trainer 300 was capable of automatically ensembling DNNs while significantly reducing unnecessary neuron retraining; (iv) the potential of CODE 302 exists even when relying only on commodity hardware. To measure these effects, the output quality of ensembles of independently trained DNNs were compared with the ones obtained by single DNNs (see Tables 1 and 2 in FIGS. 8-9A, 9B).

FIG. 1 illustrates an ensemble effect plot 100 of different Deep Neural Networks (DNNs) for the benchmarks reported in Table 1 of FIG. 8. The benchmark naming convention used is Network_Dataset (e.g., VGGtrained on the ImageNet dataset is labeled VGG_I). All benchmarks but AlexNet_M have important ensemble effects. AlexNet_M shows a small ensemble effect (+0.13%) because the quality of the single DNN instance is already high (99.21%), leaving almost no room for improvements. This ensemble effect results in a final ensemble output accuracy of 99.34%.

The ensemble effect largely results from ensemble heterogeneity: different DNN instances within the ensemble are likely to reside in different local minima of the parameter solution space.

These different optima may be a consequence of the different initial states that each DNN started training from. An ensemble of DNNs may take advantage of this local minima heterogeneity.

It was observed that the heterogeneity of the DNNs local optima is also shown through the DNNs output differences. While these differences are fundamental to generate the ensemble effect (FIG. 1), it was observed that output differences exist only for a small fraction of the network instances within a DNN ensemble, which the output outcomes originating from DNNs used for classification tasks was considered (see Tables 1 and 2 in FIGS. 8-9A, 9B).

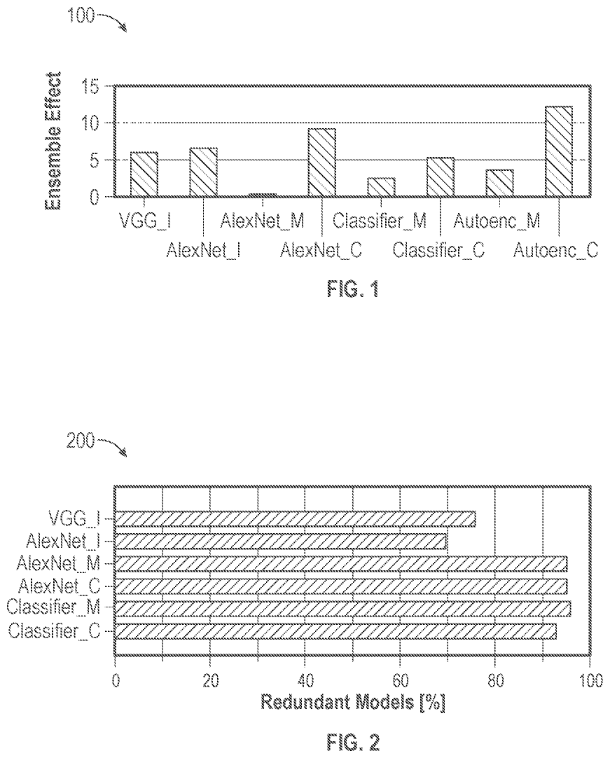

FIG. 2 illustrates redundancy contribution plot 200 caused by same outcomes generated in the ensemble composed in the DNNs. More specifically, FIG. 2 shows the fraction of independently trained DNN instances that generate an output that was already generated by at least another DNN instance of the ensemble. These fractions suggest the existence of redundancy between the networks participating in the ensembles. To compute the values shown in FIG. 2, the following formula was applied:

$$R = \frac{{\sum }_{i = 1}^{I} ( N - {U}_{i} )}{N \times I}$$

where R is the redundancy, N is the number of networks that compose the ensemble (shown in Table 1), I is the number of the inputs i . . . I, and for a given input i the term Ui is the number of unique outputs produced by the DNNs part of the ensemble. A research hypothesis is that there may be a significant amount of redundancy across DNN instances that participate in a DNN ensemble. In other words, some intrinsic aspects of the inputs may be equally learned by all the DNN instances within the ensemble. These equally-learned aspects may be called the common sub-network of an ensemble 310 (see FIG. 4), where re-learning of the common sub-network 310 for all DNN instances that compose an ensemble may not strictly be needed thus this unnecessary redundancy may be removed. An empirical evaluation on homogeneous ensembles strongly suggests that such research hypothesis is valid. This hypothesis may be implemented to automatically detect the common sub-network by comparing NDNN instances once identified, the common sub-network 310 may be extracted and linked to new DNNs ahead of training such that it will be part of their initialization. Training these additional DNN instances will only require tuning parameters that do not belong to the common sub-network of the ensemble. In particular, the new DNNs that will be part of the ensemble will only “learn” aspects of the inputs that contribute to the ensemble effect. This optimization may automatically be implemented and delivered to the end user by CODE 302.

In an example, three phases of CODE methodology may be implemented: CODE is capable of automatically ensembling DNNs while limiting unnecessary parameter retraining thanks to transformations specifically designed to analyze, identify, and remove inter-network neuron redundancy. An overview of CODE's approach is shown in FIG. 3.

FIG. 3 illustrates a Compiler-based Neuron-aware Ensemble Training system 300. The savings obtained by CODE 302 (both in terms of training time and memory used by a DNN ensemble) come from removing two sources of redundancy identified. The first source of redundancy is a consequence of the fact that DNNs are often over-sized. This source of redundancy can be detected by analyzing the contribution of a neuron to the DNN outputs. A neuron may be safely removed if, for all of its inputs, it does not contribute to the final outputs 524, 544, 564 of the DNN (see FIGS. 5A to 5C), i.e., such neurons are called dead neurons 342 (see FIG. 4). The second and main source of redundancy comes from the existence of common sub-networks 310. Common sub-networks 310 are collections of connected neurons that behave in a semantically equivalent way across different networks. After the detection and confinement of this novel source of redundancy, the training of new DNNs to be added to the ensemble will only cover parameters that are not part of the extracted common sub-network. What follows is a description of the three phases carried by CODE 302: namely, Redundancy Elimination 304, DNN generation 312, and Ensembling 316.

Phase 1: Redundancy Elimination 304. This phase starts with the training of two DNNs 530, 532 that follow the DNN architecture given as input to CODE 302. These two training sessions, including their parameters initialization may be done independently. These trained models may be called the main DNNs 308 and peer DNNs 306. Only the main DNNs 338 and peer DNNs 336 are conventionally trained because of two reasons. The first is that when more DNNs are trained, CODE 302 has less room to reduce ensemble training time. The training time saved by CODE 302 comes from unconventionally training the other DNNs 556a-556n that participate in the ensemble. The second reason is that analyzing only the main DNNs 338 and the peer DNNs 336 may lead to already obtain important training time savings (see FIG. 6). It is anyways possible for CODE 302 to analyze more than two conventionally-trained DNNs.

Once the main DNNs 308 and peer DNNs 306 are trained, CODE 302 can start the identification of the first source of redundancy thanks to its Dead Neuron Analysis (DNA) 340. DNA 340 detects all the dead neurons 342 of a DNN. We consider a neuron to be dead when its activations do not influence the outputs of the DNN it belongs to. To this end, the DNA 340 may check if the activations of a neuron are zero for all inputs considered. Neurons that meet this condition are considered dead. The DNA 340 included in CODE 302 conservatively generates a list of dead neurons from the intersection of neurons that are dead in all DNNs given as input. This differs from the conventional approach of deleting dead neurons from a single DNN after its training. In more detail, only the neurons that are dead 342 for all DNNs are chosen because a neuron can be dead in a network, but alive in another. This difference may contribute to the ensemble DNNs' heterogeneity which translates into better ensemble output quality.

It was determined to be true in the benchmarks that removed dead neurons 342 that are alive in one network but dead in the other (i.e., the conventional approach) would significantly reduce the ensemble output quality. The list of neurons generated by the DNA 340 may then be given to the Dead Neuron Elimination (DNE) component 350. This DNE component 350 removes those neurons from a given network, that is, the dead neurons 342 may be removed from the main DNN 338 and peer DNN 336 by properly modifying and reshaping their parameter tensors. This concludes the removal of the first source of redundancy identified by CODE 302.

The second source of redundancy to be removed by CODE 302 is the one given by the existence of common sub-networks 310 across homogeneous DNNs. To start the identification of neurons that will become part of the common sub-network 310, CODE 302 was used to perform a Neuron Dependence Analysis (NDA) 370. The idea that inspired the NDA 370 is simple: connected neurons that strongly influence each other need to be kept together. In machine learning this concept is called “firing together” and it is used in Hebbian learning for Hopfield networks. NDA 370 leverages the activations of each pair of connected neurons in a DNN to understand whether they should be connected in the Neuron Dependence Graph (NDG) 380. To do this, NDA 370 counts the fraction of inputs that makes both neurons “fire” together. For this test, a custom firing condition for each different neuron activation function is encoded. Connected neurons that often fire together may be linked by an edge in the NDG 380. An edge between nodes of the NDG 380 represents the constraint that connected neurons cannot be separated. In other words, either they both are selected to be part of the common sub-network 310 or neither one is. The output of the NDA 370 is the NDG 380 where all identified neurons dependencies of a DNN are stored.

Once the NDGs 380 of the main and peer network 338, 336 have been obtained, CODE 302 may perform its most crucial step: the Common Sub-Network Extraction (CSNE) 400. The CSNE 400 identifies and removes the set of semantically-equivalent neurons between the main DNN 338 and the peer DNNs 336 while satisfying the constraints specified in the NDGs 380. The CSNE 400 extracts these neurons from the main DNN 338 by reshaping its tensors and placing them in what is going to be the Common Sub-Network (CSN) 310. The semantically-equivalence may be defined as follows. A neuron nₘ of the main DNN 338 is semantically equivalent to a neuron nₚ of the peer DNN 336 if and only if all the following conditions are met: (i) nₘ and nₚ belong to the same layer (e.g., anyone of layers 1, 2 or 3 as in FIG. 5C) in their correspondent DNNs; (ii) nₘ and nₚ fire together often enough (e.g., more than 80% of the time, across the inputs considered); (iii) there is a high correlation (e.g., more than 0.8) between the sequence of activations of nₘ and the sequence of activations of nₚ; (iv) all the predecessor neurons that nₘ depends on are part of the common sub-network 310.

Condition (i) makes sure that nₘ and nₚ belong to a compatible location (e.g., layer1) in their correspondent DNNs. Conditions (ii) and (iii) check that nₘ and nₚ behave similarly for most inputs considered. Condition (iii) relies on the conventional correlation formula reported here for convenience:

$${Correlation}_{{n}_{m} , {n}_{p}} = \frac{cov ( M , P )}{{σ}_{M} {σ}_{P}}$$

where M and P are the vectors of the outputs of nₘ and nₚ. Finally, condition (iv) guarantees that the dependencies of neuron nm, specified in the NDG 380 of the DNN nₘ belongs to, are satisfied. The algorithm used by CSNE 400 flags semantically-equivalent neurons until no neurons satisfy the conditions specified above. When convergence is reached, the set of neurons to be added to the common sub-network 310 may be removed from the main DNN 308 model (i.e., main DNN without dead neurons and without the common subnetworks) via functional preserving transformations. The removed neurons are then packed into a collection of tensors that represent the extracted common sub-network 310. This common sub-network 310 that will be used by CODE 302 during its next phase called DNN generation 312.

Phase 2: DNN Generation 312—Having already trained the main DNN 308 and peer DNN 306 models, the DNN generation phase 312 of CODE 302 deals with the training of the remaining (N−2) DNNs that will be part of the ensemble. The only parameters of these DNNs that need to be trained are the ones not included in the common sub-network 310 extracted by the redundancy elimination phase 304. These trainable parameters are randomly initialized before training. In addition, the necessary common sub-network is linked to each DNN before its training. The result of this phase is (N−2) trained CODE DNNs 556a-556n. One example of CODE DNN 556a-556n is shown in FIG. 5C. The parameters that will be trained in a CODE DNN 556a-556n are labeled as “Train”.

Phase 3: Ensembling 316—The Ensembler (see 316 in FIGS. 3 and 540 in FIG. 5B) of CODE combines N DNNs to output the final DNN ensemble (see 318 FIGS. 3 and 544 in FIG. 5B). In more detail, the Ensembler 540 (see FIG. 5B) links the common sub-network 554 to the main DNN 552 and to the (N−2) CODE DNNs 556a-556n. It then adds these networks and the peer DNN 550 to the collection of DNNs that will be ensembled. The Ensembler 540 may extend this collection by introducing a component to distribute the input 546 to all N DNNs and to collect all the DNN outputs 548. The DNNs outputs 548 are combined as specified by the ensembling criterion provided to CODE 302 by the user. FIG. 5B shows the ensemble structure that the Ensembler outputs as a TensorFlow graph. Thus, the off-the shelf TensorFlow stack may be used to perform inference on the DNN ensemble 540.

Relationship with Compilers—In an example, the Computer Systems domain 300 may implement techniques called Code Analysis and Transformations (CATs) and Neuron Analysis and Transformations (NATs) including four NATs: Dead Neuron Analysis (DNA) 340, Dead Neuron Elimination (DNE) 350, Neuron Dependence Analysis (NDA) 370, Common Sub-Network Extraction (CSNE) 400. The DNA 340 and DNE 350 are similar in spirit to the dead code elimination CAT, NDA 370 and CSNE 400 are inspired by common sub-expression elimination performed by conventional compilers.

Compiler Implementation—CODE may be implemented in ˜30,000 lines of code. In an example, the CODE compiler 302 may implement a combination of Python® and C++ code. Python code has been used to interact with the TensorFlow stack, and C++ has been used to implement the core of CODE 302, including all NATs earlier described. It is found that the time spent inside NATs is negligible (less than 0.05% of the total training time) due to a careful parallelization and vectorization of their code using OpenMP 4.5®.

EMPIRICAL EVALUATION: CODE may be evaluated on several benchmarks and its results were compared with a baseline of homogeneous ensembles of independently trained DNNs. For example, all experiments may be leveraged TensorFlow r1.12 on a single Nvidia GTX 1080Ti GPU.

FIG. 4 illustrates a method of redundancy elimination in the Compiler-based Neuron-aware Ensemble training. Benchmarks evaluations—The naming convention used for the benchmarks evaluated is Network_Dataset. For example, the AlexNet that was trained on the MNIST dataset is called AlexNet M.

FIG. 6 illustrates training time needed by CODE to achieve the same output quality of the baseline of Table 1. FIG. 7 illustrates a CODE Ensembles memory footprint with respect to base line for the entries of Table 1.

The set of networks tested CODE on may include the following DNNs: Autoencoder: an unsupervised learning network, which was made of five fully connected hidden layers: encode1,encode2, code, decode1, decode2. In an example, layers encode1 and decode2 may have the same neuron cardinality, and so do layers encode2 and decode1. Autoencoder's task is to generate a noiseless image starting from a noisy input image. Its output quality over a dataset may be measured in terms of mean squared error (MSE) between the original images and the output images.

Referring to FIGS. 6-7, the Classifier network may be meant to learn how to classify an input over a number of predefined classes. Its structure may consist of four fully connected hidden layers with different neuron cardinalities. Its output quality over a dataset may be measured in terms of accuracy, i.e. correct predictions over total predictions.

Referring to FIGS. 6-7, the AlexNet network may be designed for image classification. This network may come in two variants: four hidden layers, and eight hidden layers. Google® code from the version distributed (Google, a). Unlike the other two networks (i.e., Classifier_C and Classifier_M), network AlexNet may make use of convolutional layers. These particular layers may take advantage of the spatial location of the input fed to them. The AlexNet output quality was measured in terms of accuracy.

Referring to FIGS. 6-7, the VGG network may be designed for image classification. This network may come in six variants. The peculiarity of this DNN network is the use of stacked convolutional layers. The VGG output quality was measured in terms of accuracy.

In an example, the network code may be an adapted version where convolutional layers may be replaced with fully connected layers, and image noise has been obtained by applying dropout to the input layer.

The datasets used for performance tests include: MNIST: a dataset composed of 70000 entries containing handwritten digits. Each entry is pair of a 28×28 pixels gray-scale image and its corresponding digit label. CIFAR10 is a dataset of 60000 images of objects categorized in 10 different classes. Each 32×32 pixels color image is labeled according to the class it belongs to, e.g. “airplane”, “automobile”, “dog”, “frog”. The ImageNet dataset may be one of the state-of the-art datasets for image classification and object detection. The variant used contains over 1.2 million entries of color images distributed over 1000 classes. These images may have different sizes: they were resized to have a minimum length or height of 256 pixels and took the central 256×256 pixels crop. For each dataset, with the exception of ImageNet, no data preprocessing was performed other than normalizing the input features of each image.

When training AlexNet on ImageNet, the mean image was computed over the whole dataset and then subtracted it from every image given as input to the network. When training VGG on Imagenet, the mean RGB pixel over the whole dataset was computed and then subtracted it from every pixel of any image given as input to the network. During training on ImageNet, data augmentation was performed by providing the network with one random 224×224 pixels image crop taken from the initial 256×256 pixels central crop.

Ensembling criteria: multiple ensembling criteria were considered, including majority voting, averaging, products of probability distributions, and max. The criterion that gave the best output quality for ensembles of independently trained DNNs was chosen.

When accuracy is the metric used to measure the output quality of a model, the following ensembling criterion was applied. For an ensemble of N models that outputs K class probabilities per input, the ensemble output probabilities for the ith input may be computed as:

$${P}_{ik} = {\prod }_{j = 1}^{N} {O}_{ijk}$$

where Pᵢₖ is the predicted probability of input i to belong to class k, Oᵢⱼₖ is the output probability for class k of the jth model in the ensemble for the ith input. The predicted label Lᵢ of a given input is computed as:

Lᵢ=max {Pᵢ₁, . . . , P_{iK}}

The accuracy metric may be computed as the number of correctly predicted labels over the total number of inputs. The higher the accuracy, the better.

When cumulative MSE is the metric used to measure the output quality of model, the following ensembling criterion was applied. For an ensemble of N models where K is the number of dimensions of each input, the ensemble output value for the kth dimension of the ith input is computed as:

$${V}_{ik} = \frac{{\sum }_{j = 1}^{N} {O}_{ijk}}{N}$$

Where Oᵢⱼₖ is the output value for dimension k of the jth model in the ensemble for the ith input. The MSE is then computed between the ensemble output Vi and the expected output Ei. The sum of all the MSEs gives us the cumulative MSE metric. The lower the MSE, the better.

DNN Training: the off-the-shelf Tensorflow® software stack may be used to train every DNN on a single GPU. Parallel training of each single DNN is anyways possible by leveraging frameworks such as Horovod®. Learning rate tuning has been done for the baseline runs, and the same learning rate has been used for CODE runs. Weight decay has not been used during training and learning rate decay has only been used for AlexNet_I and VGG_I benchmarks. Early stopping has been leveraged to halt the training session when no output quality improvement on the validation set has been observed for 5 consecutive training epochs.

The measurements have been obtained by running each experiment multiple times. AlexNet_I has been run 3 times and VGG_I has been run only once due to the extensive amount of time it required to complete a single run on our machine. All other benchmarks shown in Table 1 (see FIG. 8) have been run for 30 times. We reported the output quality median of baseline and CODE ensembles, together with their training times, in Table 1 in FIG. 8.

Results: Training time savings Training a DNN ensemble requires the choice of its cardinality, i.e. how many models will be part of the ensemble. For each entry in Table 1, it was reported the baseline ensemble cardinality N_{Baseline} that led to diminishing returns in terms of output quality scored by each of our benchmarks. Baseline ensembles are made of independently trained networks. CODE ensembles 300 have been trained by following the approach was described in FIG. 3. For each benchmark, the total training time needed by CODE 302 was measured to obtain at least the same output quality of the baseline ensemble and reported its cardinality N_{CODE}. The results of these comparisons are reported in Table 1 and FIG. 6. Thanks to its NATs, CODE obtained the output quality of the baseline ensembles in a fraction of the time. On average, CODE reaches the same or better baseline ensemble output quality using only 43.51% of the baseline training time. The combined advantages of redundancy reduction and avoiding the retraining of the common sub-network 310 are the keys that led CODE 302 to achieve important training time savings. It is worth noting that, CODE NATs accounted for less than 0.05% of the total ensemble training time.

For completeness, the total memory footprint of the CODE ensembles reported in Table 1 was computed. To do so, the following formula was used:

$$M = \frac{{TP}_{DNN} + ( {N}_{CODE} - 1 ) \cdot {TP}_{{CODE}_{DNN}} + CSN}{{N}_{Baseline} \cdot {TP}_{DNN}}$$

where M is the memory footprint of the CODE ensemble with respect to the baseline ensemble, TP is the number of trainable parameters, CSN is the number of non-trainable parameters stored in the common sub-network, and N_{CODE} and N_{Baseline} are ensemble cardinalities. These results are shown in FIG. 7. On average, CODE ensembles (or DNN ensemble 318) have 52.38% of the baseline memory footprint (see FIG. 7). These memory savings result from the sharing of the common sub-network 310 enforced by CODE 302.

Higher output quality: The training time savings described can be exploited by CODE 302 to achieve higher output quality. While not exceeding the training times of the baseline ensembles specified in Table 1, CODE 302 can invest those savings by training more DNNs to add to its ensembles. In Table 2 (see FIGS. 9A, 9B) it is shown that the extra output quality that CODE 302 obtained when given the same training time budget as the baseline. CODE 302 increases the output quality of most benchmarks (up to 8.3%) without exceeding the training time used by the baseline. For completeness, the extra output quality gained were also measured and reported when no training time constraints are given to both the baseline and CODE, i.e. when any number of models can be added to the ensemble. It was observed that the baseline does not meaningfully increase its output quality even when its training time budget is left unbounded. On the other hand, CODE obtains higher output quality out of its trained ensembles.

RELATED WORK: It is shown that the relevance of ensembling DNNs and present the spectrum of community investments. Prior work related to improving DNNs was divided into multiple categories: fast ensembling, optimizing training time, optimizing inference time, software stacks.

Ensembling Deep Neural Networks: Combining the outputs of multiple DNNs is a common technique used to perform better on a given metric (e.g. accuracy, MSE) for a given task (e.g. classification, object detection). Ensembling can be performed across networks (e.g. Inception-V4, GoogLeNet and/or within networks. The outcomes of the last five ImageNet Large Scale Visual Recognition Challenges are a strong proof of this trend: ensembling models proved to be the winning strategy in terms of task performance. In unsupervised language modeling, ensembles of multiple models often outperform single models by large margins. Another example of the importance of ensembling is shown on the MNIST classification task. The best accuracy was obtained by a multitude of different networks. The entry that set the best tracked result is an ensemble of 35 Convolutional Neural Networks. To the best of our knowledge, ours is the first work to propose and evaluate methods aimed specifically at optimizing the training of ensembles for general DNNs while preserving output quality.

Fast Ensembling: A standard baseline for ensembling DNNs is to aggregate a set of independently trained deep neural networks. To reduce ensemble training time, existing fast ensembling techniques rely on two main ideas: transfer learning and network architecture sharing.

Transfer learning based approaches include Knowledge Distillation and Snapshot Ensembles. Knowledge Distillation method may train a large generalist network combined with multiple specialist networks trained on specific classes or categories of a dataset. The Snapshot Ensembles method averages multiple local minima obtained during the training of a single network.

Network architecture sharing based techniques include TreeNets and MotherNets. The idea behind TreeNets is to train a single network that branches into multiple sub-networks. This allows all the learners to partially share few initial layers of the networks. Along this line of thinking, MotherNets targets structural similarity to achieve faster training times. At its core, MotherNets first trains a “maximal common sub-network” among all the learners and then transforms it back into the original models' structures through functional preserving transformations. All these models are then further trained until convergence is reached.

All the works mentioned above do not preserve the output quality of the baseline ensembles of independently trained networks when training faster than baseline, while CODE manages to do so.

CODE relies on both transfer learning and network architecture sharing by focusing on functional (rather than structural) similarity. This enabled CODE to preserve the baseline accuracy while delivering training time savings, a substantial improvement over previous approaches. The core idea of CODE is to avoid unnecessary redundant training of neurons that exist in ensembles of neural networks. CODE achieves this goal by identifying and extracting semantically equivalent neurons from networks that have the same architecture.

Optimizing Training Time : Training time optimization has mainly been achieved thanks to hardware accelerators hardware-specific libraries, training strategies, neuron activation functions. Latte® showed preliminary results on how a compiler can achieve training time improvements through kernel fusion and loop tiling. Intel nGraph® leverages fusion, memory management and data reuse to accelerate training. Nevertheless, neither Latte® nor nGraph® explicitly target ensembles of DNNs: these optimization techniques are orthogonal to the method of the disclosure or could be combined with the disclosed approach in future works.

CONCLUSION: In this work CODE 302, a compiler-based approach to train ensembles of DNNs is disclosed. CODE 302 managed to achieve the same output quality obtained by homogeneous ensembles of independently trained networks in a fraction of their training time and memory footprints. It is shown that the existence of redundancy within ensembles of DNNs deserves more attention. Redundancy not only negatively influences the final ensemble output quality but also hurts its training time. Ensembles of neural networks are targeted and more is to be added to neuron level analyses. In its current iteration, CODE 302 is capable of finding semantically-equivalence in neurons within fully connected layers across homogeneous networks. CODE can anyway be extended to support heterogeneous ensembles by means of functional-preserving architectural transformations. As an immediate future step, we aim to extend CODE 302 to handle more sophisticated network architectures such as Inception® and ResNet® by adding support for neurons within convolutional layers to be part of common subnetworks.

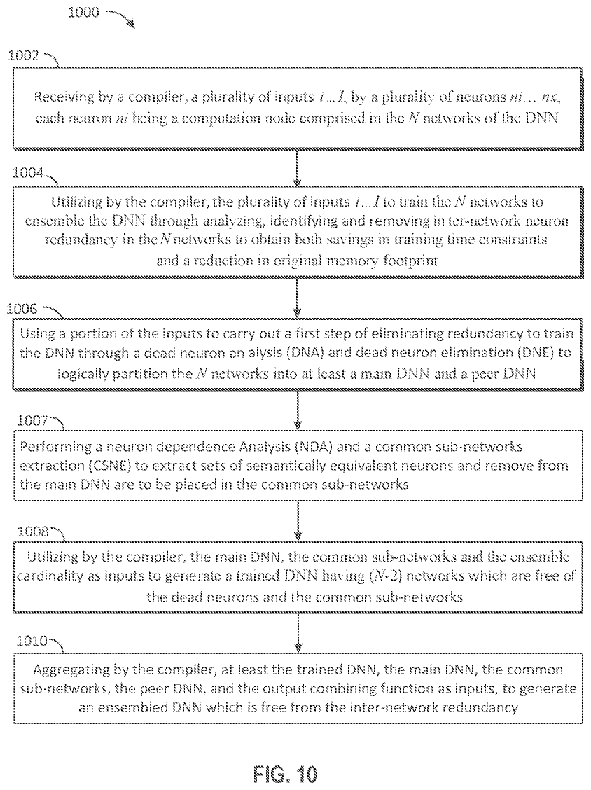

FIG. 10 is a flow chart illustrating a method of the Compiler-based Neuron-aware Ensemble training as depicted in FIGS. 3 and 4. The method may be a Deep Neural Network (DNN) ensemble training, which is executed by at least a processor 390 in a computer (e.g., a server or cloud computing), program code including a compiler (e.g., CODE 302) which is stored in a non-transitory computer-readable medium (e.g., a memory), wherein the compiler configures a Deep Neural Network (DNN) into N networks to perform the following training steps:

In step 1002, receiving by a compiler (e.g., CODE 302 in FIG. 3), a plurality of inputs i . . . I, by a plurality of neurons ni nx, wherein each neuron ni being a computation node comprised in the N networks of the DNN.

In step 1004, utilizing by the compiler, the plurality of inputs i . . . I to train the N networks to ensemble the DNN through analyzing, identifying and removing inter-network neuron redundancy in the N networks to obtain both savings in training time constraints and a reduction in original memory footprint. In an example, the plurality of inputs i . . . I may include one or a combination of: a tensor flow graph describing a DNN 320a, a training dataset 320b, a validation dataset 320c, an ensemble cardinality 320d and an ensemble combining function 320e.

In step 1006, the compiler (e.g., CODE 302) may utilize a portion of the inputs i . . . I (the tensor flow graph 320a, the training dataset 320b and the validation dataset 320c) to train the main DNN 360 and a peer DNN 306. The compiler may carry out a first step of eliminating redundancy through a dead neuron analysis (DNA 340) and dead neuron elimination (DNE 350) to logically partition the N networks into at least a main DNN 360 and a peer DNN 306, wherein dead neurons 342 that do not contribute to any of unique outputs Ui . . . UI (e.g., outputs 548 in FIG. 5) have been eliminated in both the peer DNN 306 and in the main DNN 360. In implementation, the main DNN 360 that is free from the dead neurons 342 is subjected to neuron dependence analysis (NDA 370) to identify connected neurons that are caused to fire together according to different neuron activation functions provided to a fraction of the plurality of inputs, wherein the connected neurons that fire together are linked together by an edge in a neuron dependence graph (NDG 380).

In step 1007, the step of eliminating redundancy further including the compiler performing the neuron dependence analysis (NDA) and a step of common sub-networks extraction (CSNE 400), such that sets of semantically equivalent neurons are to be extracted and removed from the main DNN 360, and to be placed in the common sub-networks 310, such that the main DNN 308 is free from both the dead neurons 342 and the common sub-networks 310, wherein the common sub-networks 310 are formed by connected neurons that behave in a semantically equivalent way across different networks.

The eliminating redundancy step 1007 is followed by step 1008, utilizing by the compiler: the main DNN 308, the common sub-networks 310 and the ensemble cardinality 320d as inputs to generate (N−2) trained DNN 314 that are free of the dead neurons 314 and the common sub-networks 310.

Step 1008 of DNN generation is followed by carrying out step 1010 of ensembling the trained DNN, which includes aggregating by the compiler at least the (N−2) trained DNNs 314, the main DNN 308, the peer DNN 306, the common sub-networks 310, and the output combining function 302e as inputs to generate an ensembled DNN 318 which is free from the inter-network neuron redundancy.

In practice, the processor 390 that executes the program code of the compiler may be implemented by one of or a combination of: a plurality of Graphical Processing Units (GPUs) and a plurality of Tensor Processing Units (TPUs).

Other systems, methods, features and advantages will be, or will become, apparent to one with skill in the art upon examination of the figures and detailed description. It is intended that all such additional systems, methods, features and advantages be included within this description, be within the scope of the disclosure, and be protected by the following claims.

What is claimed is:

1. A method for training a Deep Neural Network (DNN) ensemble, comprising:
executing by at least a processor in a computer, program code comprising a compiler which is stored in a non-transitory computer-readable medium, wherein the compiler configures a Deep Neural Network (DNN) into N networks to perform training steps comprising:
receiving, a plurality of inputs i . . . I, by a plurality of neurons ni . . . nx, wherein each neuron ni being a computation node comprised in the N networks of the DNN; and
utilizing by the compiler, the plurality of inputs i . . . I to train the N networks to ensemble the DNN through analyzing, identifying and removing inter-network neuron redundancy in the N networks to obtain both savings in training time constraints and a reduction in original memory footprint.

2. The method according to claim 1, wherein the plurality of inputs comprising one or a combination of: a tensor flow graph describing a DNN, a training dataset, a validation dataset, an ensemble cardinality and an ensemble combining function.

3. The method according to claim 2, wherein the analyzing, identifying and removing of the inter-network neuron redundancy comprises: using a portion of the plurality of inputs to train at least a main DNN and a peer DNN, wherein the compiler carrying out a first step of eliminating redundancy from the main DNN and a peer DNN through a dead neuron analysis (DNA) and a dead neuron elimination (DNE).

4. The method according to claim 3, wherein the portion of the plurality of inputs comprises: the tensor flow graph, the training dataset and the validation dataset as inputs by the compiler to carry out the first step of eliminating redundancy to train the DNN through the dead neuron analysis (DNA) and the dead neuron elimination (DNE) to logically partition the N networks into at least the main DNN and the peer DNN, wherein dead neurons do not contribute to any of unique outputs Ui . . . UI have been eliminated in both the peer DNN and in the main DNN through the DNA and DNE.

5. The method according to claim 4, wherein the main DNN that is free from the dead neurons is subjected to neuron dependence analysis (NDA) to identify connected neurons that are caused to fire together according to different neuron activation functions provided to a fraction of the plurality of inputs, wherein the connected neurons that fire together are linked together by an edge in a neuron dependence graph (NDG).

6. The method according to claim 5, wherein the first step of eliminating redundancy further comprising performing a step of common sub-networks extraction (CSNE), such that sets of semantically equivalent neurons that are extracted and removed from the main DNN are to be placed in the common sub-networks, such that the main DNN is free from the dead neurons and the common sub-networks, wherein the common sub-networks comprises connected neurons that behave in a semantically equivalent way across different networks.

7. The method according to claim 6, wherein the first step of the eliminating redundancy is followed by carrying out a second step of DNN generation, comprising utilizing by the compiler: the main DNN, the common sub-networks and the ensemble cardinality as inputs to generate a trained DNN having (N−2) networks which are free of the dead neurons and the common sub-networks.

8. The method according to claim 7, wherein the second step of DNN generation is followed by carrying out a third step of ensembling the trained DNN, comprising: aggregating by the compiler, at least the trained DNN, the main DNN, the common sub-networks, the peer DNN, and the output combining function as inputs, to generate an ensembled DNN which is free from the inter-network neuron redundancy.

9. The method according to claim 8, comprising the compiler implementing a combination of Python code written to interact with a tensor flow stack and C++ code written to implement the identifying and removing of the inter-network neuron redundancy.

10. The method according to claim 1, wherein the plurality of neurons ni nx comprised in the DNN are implemented by one of or a combination of: a plurality of Graphical Processing Units (GPUs) and a plurality of Tensor Processing Units (TPUs).

11. A system for training a Deep Neural Network ensemble, comprising:
comprising a plurality of neurons ni . . . nx, wherein each neuron ni being a computation node in the DNN; and
at least a processor in a computer that executes program code comprising a compiler which is stored in a non-transitory computer-readable medium, wherein the compiler is enabled to configure a Deep Neural Network (DNN) into N networks to perform training steps, comprising:
receive a plurality of inputs i . . . I by a plurality of neurons ni . . . nx, wherein each neuron ni being a computation node comprised in the N networks of the DNN; and
utilize the plurality of inputs i . . . I to train the N networks to ensemble the DNN through analyzing, identifying and removing inter-network neuron redundancy in the N networks to obtain both savings in training time constraints and a reduction in original memory footprint.

12. The system according to claim 11, wherein the plurality of inputs comprising one or a combination of: a tensor flow graph describing a DNN, a training dataset, a validation dataset, an ensemble cardinality and an ensemble combining function.

13. The system according to claim 12, wherein the analyzing, identifying and removing of the inter-network neuron redundancy comprises: using a portion of the plurality of inputs to train at least a main DNN and a peer DNN, wherein the compiler carrying out a first step of eliminating redundancy from the main DNN and a peer DNN through a dead neuron analysis (DNA) and a dead neuron elimination (DNE).

14. The system according to claim 13, wherein the portion of the plurality of inputs comprises: the tensor flow graph, the training dataset and the validation dataset as inputs by the compiler to carry out the first step of eliminating redundancy to train the DNN through the dead neuron analysis (DNA) and the dead neuron elimination (DNE) to logically partition the N networks into at least the main DNN and the peer DNN, wherein dead neurons that do not contribute to any of unique outputs Ui . . . UI have been eliminated in both the peer DNN and in the main DNN through the DNA and DNE.

15. The system according to claim 14, wherein the main DNN that is free from the dead neurons is subjected to neuron dependence analysis (NDA) to identify connected neurons that are caused to fire together according to different neuron activation functions provided to a fraction of the plurality of inputs, wherein the connected neurons that fire together are linked together by an edge in a neuron dependence graph (NDG).

16. The system according to claim 15, wherein the first step of eliminating redundancy further comprising performing a step of common sub-networks extraction (CSNE), such that sets of semantically equivalent neurons that are extracted and removed from the main DNN are to be placed in the common sub-networks, such that the main DNN is free from the dead neurons and the common sub-networks, wherein the common sub-networks comprises connected neurons that behave in a semantically equivalent way across different networks.

17. The system according to claim 16, wherein the first step of the eliminating redundancy is followed by carrying out a second step of DNN generation, comprising utilizing by the compiler: the main DNN, the common sub-networks and the ensemble cardinality as inputs to generate a trained DNN having (N−2) networks which are free of the dead neurons and the common sub-networks.

18. The system according to claim 17, wherein the second step of DNN generation is followed by carrying out a third step of ensembling the trained DNN, comprising: aggregating by the compiler, at least the trained DNN, the main DNN, the common sub-networks, the peer DNN, and the output combining function as inputs, to generate an ensembled DNN which is free from the inter-network neuron redundancy.

19. The system according to claim 18, comprising the compiler implementing a combination of Python code written to interact with a tensor flow stack and C++ code written to implement the identifying and removing of the inter-network neuron redundancy.

20. The system according to claim 11, wherein the plurality of neurons ni . . . nx comprised in the DNN are implemented by one of or a combination of: a plurality of Graphical Processing Units (GPUs) and a plurality of Tensor Processing Units (TPUs).
